(19) United States
(12) Patent Application Publication
(10) Pub. No.: US 2015/0369502 A1
(43) Pub. Date: Dec. 24, 2015

(54) RESIDENTIAL HVAC CONTROL SYSTEM

(71) Applicant: Ira M Turner, Niantic, CT (US)

(72) Inventor: Ira M Turner, Niantic, CT (US)

(21) Appl. No.: 14/741,348

(22) Filed: Jun. 16, 2015

Related U.S. Application Data
(60) Provisional application No. 62/014,071, filed on Jun. 18, 2014.
(60) Provisional application No. 62/027,202, filed on Jul. 21, 2014.

(51) Int. Cl. F24F 11/00; G05B 15/02

(52) U.S. Cl. CPC F24F 11/006; F24F 11/0012; F24F 11/0086; G05B 15/02; F24F 2011/0013; F24F 2011/0047; F24F 2011/0057; F24F 2011/0064; F24F 2011/0068; F24F 2011/0094

(57) ABSTRACT

An energy control system is configured for regulating consumption of an energy supply by a residential heating, ventilation or air conditioning (HVAC) device. The energy control system includes a monitoring device configured for monitoring energy consumption by the residential HVAC device; a user interface for inputting a usage plan and inputting a budget for the energy supply; and a system controller for providing a revised usage plan by adjusting the usage plan to limit the energy consumption to conform with the budget.

### CROSS REFERENCE TO RELATED APPLICATIONS

This application is filed under 35 U.S.C. §111(a) and 37 CFR 1.53(b), and claims under 35 U.S.C. §119(e) the benefit of prior-filed provisional applications No. 62/027202, filed Jul. 21, 2014, entitled “Feedstock Control System;” and, 62/014071, filed Jun. 18, 2014, entitled “Tank Monitoring System,” the disclosures of which are incorporated herein in their entireties.

### BACKGROUND OF THE INVENTION

1. Field of the Invention

The invention disclosed herein relates to control systems that monitor energy use and/or supply, process usage and other data to adjust energy consumption according to user defined criteria.

2. Description of the Related Art

The increasingly fast-paced world makes accomplishing many routine tasks more complicated. Consider that many people spend more and more time away from home. While this is often the case, the home is still a base of operations for everything else. Accordingly, many tools that provide for automation of the home assist users with maintaining the estate and are increasingly a necessity.

Home automation controls provide users with a good deal of flexibility. For example, remote systems that permit users to control and monitor alarm systems, lighting and the like provide homeowners with increased confidence, flexibility and may provide for some cost savings.

Unfortunately, some aspects of energy systems remain in an antiquated form. That is, it is presently impossible for users to monitor many aspects of home heating. Consider, for example, that homeowners that heat with oil are generally required to go to the basement (or wherever the oil tank is located) to determine how much oil is left in the tank. With an increasingly mobile lifestyle, this is sometimes only remembered when away from the residence.

Further, with the ever increasing cost of energy, the resources of homeowners are often strained during peak demand.

Thus, what are needed are control systems that provide for enhanced control over residential heating, ventilation and air conditioning or cooling systems. Preferably, the control systems provide users with automated and flexible implementation of a budget.

### SUMMARY OF THE INVENTION

In one embodiment, an energy control system is provided. The energy control system is configured for regulating consumption of an energy supply by a residential heating, ventilation or air conditioning (HVAC) device. The energy control system includes a monitoring device configured for monitoring energy consumption by the residential HVAC device; a user interface for inputting a usage plan and inputting a budget for the energy supply; and a system controller for providing a revised usage plan by adjusting the usage plan to limit the energy consumption to conform with the budget.

The monitoring device may include at least one of a supply monitor and a usage monitor. The supply monitor may include a device configured for monitoring the quantity of one of a liquid and a gas. The usage monitor may include a device for monitoring at least one of flow of a liquid, flow of a gas, and usage of electricity. The system controller may be configured to factor third-party data into the revised usage plan. The third-party data may include at least one of: outdoor temperature, indoor temperature, building description information, and HVAC performance characteristics. The energy control system may include a user interface for inputting at least one of the usage plan and the budget. The user interface may be presented to the user by one of: a thermostat, a personal computer, a tablet computer, a mobile computing device and a smart phone. The monitoring device may include at least one of: an ultrasonic sensor, a mechanical sensor, a pressure sensor, a capacitive sensor, an acoustic sensor, and an optoelectronic sensor. The monitoring device may include at least one of a device controller, memory, and a communications channel for communicating with the system controller.

In another embodiment, the method for fabricating energy control system is provided. The energy control system is for an HVAC device installed within a residential dwelling, and includes: selecting a monitoring device configured for monitoring energy consumption by the residential HVAC device; selecting a user interface for inputting a usage plan and inputting a budget for the energy supply; and, providing a system controller for providing a revised usage plan by adjusting the usage plan to limit the energy consumption to conform with the budget.

The system controller may include a set of computer executable instructions stored on non-transitory machine readable media, the instructions configured for: receiving the usage plan, the budget and consumption information; and, calculating at least one offset value for the usage plan to provide the revised usage plan. The system controller may be configured to perform the receiving and the calculating autonomously.

In another embodiment, the computer program product is provided. The computer program product includes a set of computer executable instructions stored on non-transitory machine readable media, the instructions configured for managing a residential HVAC energy control system by implementing a method including: receiving a usage plan, a budget and consumption information for a residential HVAC device; and, providing a revised usage plan by adjusting the usage plan to limit the energy consumption to conform with the budget.

The receiving may further include receiving third-party data that includes at least one of outdoor temperature, indoor temperature, building description information, and HVAC performance characteristics. The computer program product may further include instructions for monitoring correlation of the revised usage plan the budget and the third-party data.

The computer program product may further include instructions for adjusting factors derived from correlation data and used in algorithms for providing the revised usage plan. The computer program product may further include a remote server configured for receiving at least one of correlation data, algorithms, third-party data, usage plan data, budget data, and revised usage plan data. The remote server may be configured to derive improved algorithms based on the received data. The computer program product may further include at least one driver configured for enabling communication between a system controller and another component. The computer program product may include instructions for providing a revised usage plan for at least one zone of a plurality of zones.

### BRIEF DESCRIPTION OF THE DRAWINGS

The features and advantages of the invention are apparent from the following description taken in conjunction with the accompanying drawings in which:

FIG. 1 is an schematic diagram depicting aspects of an energy control system;

FIGS. 2A and 2B, collectively referred to herein as FIG. 2, present exemplary graphs depicting average outdoor temperature and depletion of an energy supply;

FIG. 3 is a block diagram depicting aspects of the energy control system;

FIG. 4 is a flow chart depicting an ongoing process for regulating consumption with the energy control system of FIGS. 1 and 3;

FIG. 5 is an exemplary user interface for adding user data to the energy control system;

FIG. 6 is a schematic diagram depicting aspects of a computer useful for implementing aspects of the energy control system; and,

FIG. 7 is a block diagram depicting exemplary aspects of a computer suited for use with the energy control system.

### DETAILED DESCRIPTION OF THE INVENTION

Disclosed herein are control systems for monitoring and controlling use of an energy supply according to a budget imposed by a user. The energy control systems disclosed provide for budgeting consumption of the energy supply in concert with a usage plan. Generally, a user will input settings to define the usage plan, and will also input control criteria for the system to budget use of the energy supply. Once an installation of the control system is operational, the usage plan will be modified as needed and on an ongoing basis to conform to the budget.

In an illustrative embodiment, the energy supply includes a tank full of home heating oil. The usage plan includes a heating schedule as may be input into a conventional programmable thermostat. The usage plan may include a series of days, times and corresponding temperature settings. The budget may include minimum refill date for the tank. More specifically, the budget may include the earliest date the user can afford to refill the tank. The budget may include a variety of criteria for adjusting the usage plan. Examples include making greater reductions in heating usage for selected zones and/or reductions during specified days or times.

The control system may then use characteristics of the HVAC systems, external data (such as outdoor temperature) and other parameters to ensure usage remains within the budget. Accordingly, the user may effectively budget consumption of the energy supply.

In the illustrative embodiment set forth herein, the energy supply is fuel oil that is used for heating a home. However, the energy supply may include any form of energy suited for residential heating, ventilation and air conditioning or cooling (HVAC) systems.

In order to provide some context for the teachings herein, some aspects are introduced below.

As discussed herein, the terms “automatic” and “automated” generally refers to a process that is initiated in response to an event and without human interaction. The terms “semi-automatic” and “semi-automated” generally refers to processes that are initiated with limited human interaction, such as those processes that may require some human input for completion.

As discussed herein, the term “autonomous” generally refers to continuing decision making behavior based upon pre-programmed logic. For example, the control system may be configured to operate autonomously once set up has been completed.

As discussed herein, the term “budget” generally refers to user established requirements for controlling consumption of the energy supply. The budget may include a set of criteria that are input to the energy control system and are intended to be used by the energy control system to adjust a usage plan. A budget may be determined according to external criteria, such as funds available for purchase of energy. The budget may include any criteria deemed appropriate for modifying consumption of the energy supply.

As discussed herein, the term “continuing basis” generally refers to an ongoing process. Tasks may be perceived as being performed on a continuing basis, while merely being performed at periodic intervals that are adequate to satisfy the needs of a user and to provide a desired level of sensitivity. For example, a “continuing basis” is not meant imply that a processor is constantly processing at or near capacity of the processor. Rather, in this example, the processor processes tasks on a continuing basis when the system processes often enough to provide a desired level of control over consumption. In some embodiments, it may be adequate that a process is implemented on a continuing basis if data is collected and/or evaluated once every hour. Accordingly, the term “continuing basis” should be construed as performance of a task at an interval or frequency that is adequate to meet a defined level of performance, and is not limited to performance at or near the capabilities of components assigned the task.

As used herein, the term “energy supply” generally refers to feedstock that may be used in heating, ventilation and cooling (HVAC) applications. Suitable forms of energy include those where consumption of the energy supply is controllable through use of at least partially automated or autonomous control systems. Exemplary forms of energy supplies include, without limitation: home heating oil, kerosene, number two fuel oil, propane, natural gas, alcohol, electricity (provided through an external line, by an energy storage or by other source), coal and other such sources. In some embodiments, other fuel supplies such as wood or coal may be used (through, for example, control of a supply of air to a combustion chamber, or other engineering controls).

As used herein, the terms “HVAC device” and “HVAC component” include conventional devices used for heating, ventilation or air conditioning (or cooling) and that consume energy of the energy supply to provide the desired climate or environment. For point of clarity, and HVAC device may or may not be capable of providing all three of heating, ventilation and air-conditioning. Conventional HVAC devices typically are configured to provide one or two of the foregoing capabilities.

HVAC devices that may be suited for control with the energy control system disclosed herein include, without limitation, systems employing: an atmospheric burner, a boiler, a finned-tube boiler, a low-pressure steam boiler, a hot water boiler, a condensing furnace, a condensing boiler, a noncondensing system, a single-stage burner, a two-stage burner, a modulating burner, a unvented system, a direct vent system, and indoor system, and outdoor system, a system with electronic ignition, the system with a pilot light, an isolated combustion system, a power burner, and other types of such devices.

As used herein, the term “supply monitor” generally refers to an apparatus that is configured to monitor a remaining quantity of an applicable energy supply. In the exemplary embodiment, the supply monitor includes a tank monitor that monitors a remaining volume of home heating oil within an oil tank. The supply monitor may be as simple as a sensor that is in communication with remote processing capabilities. The supply monitor may be an integrated device that includes a sensor, processing capabilities, data storage, a power supply and other such components. In short, the supply monitor may be any type or configuration of device that provides for monitoring the remaining quantity of the applicable energy supply with adequate sensitivity.

As used herein, the term “usage monitor” generally refers to an apparatus that is configured to monitor usage (for example, the rate of consumption) of an applicable energy supply. In the exemplary embodiment, the usage monitor includes a flow meter that monitors flow of home heating oil from the oil tank (that is, in the exemplary embodiment, the usage monitor monitors volume used as a function of time). The usage monitor may be as simple as a sensor that is in communication with remote processing capabilities. The usage monitor may be an integrated device that includes a sensor, processing capabilities, data storage, a power supply and other such components. In short, the usage monitor may be any type or configuration of device that provides for monitoring consumption of the applicable energy supply with sensitivity that is adequate for operation of the energy control system.

As discussed herein, the term “usage plan” generally refers to a set of criteria that reflect demand that is to be placed on the energy supply. In simple terms, this may include a thermostat setting, a thermostat schedule (for a programmable thermostat), or other similar technique for defining need. For example, the usage plan may simply call for each heating zone to be maintained at 68 degrees Fahrenheit. Another usage plan may call for selected heating zones to be maintained at 68 degrees Fahrenheit between 6 AM and 11 PM, and to reduce those selected heating zones to 64 degrees Fahrenheit in the off hours.

As discussed herein, the term “revised usage plan” generally refers to an instance of a usage plan that has been adjusted according to a given budget. The adjustments to the usage plan may in consideration of performance characteristics of the HVAC device being controlled, as well as other conditions such as external temperature, building insulation and the like. The revised usage plan provides for adjustment to the environmental conditions within the designated control area. For example, within a residential dwelling.

As discussed herein, the term “residential” generally refers to systems and components as may be used in a residential dwelling. That is, a dwelling used for personal habitation. HVAC devices and other components used in a residential dwelling are known to be substantially different than commercial or industrial devices. Among other things, residential HVAC devices are generally more simple in design and do not include a variety of features that may be available in a commercial or industrial counterparts. Generally, residential HVAC devices discussed herein include HVAC components that are governed by or designed in accordance with appropriate building codes. Exemplary building codes include those promulgated by American National Standards Institute (ANSI) and The Indoor Environment & Energy Efficiency Association (ACCA). One exemplary standard includes the Residential Systems Overview (Manual RS), available from the ACCA. Other HVAC standards and guidelines with varying degrees of applicability that are from ACCA include: Manual J, Load Calculation; Manual S, Equipment Selection; Manual D, Duct Design; Manual T, Air Distribution; Manual B, Testing, Adjusting & Balancing; and Manual Zr, Residential Zoning.

Additional standards for residential HVAC devices and systems are set forth by American Society of Heating, Refrigerating and Air-Conditioning Engineers (ASHRAE), which provides a variety of standards and guidance. In some embodiments, the term “residential” with regards to residential HVAC devices applies to central furnaces with inputs less than 225,000 BTU/h and boilers with inputs less than 300,000 BTU/h. The furnaces and/or boilers may have gas, oil, or electric input. In some embodiments, air-conditioning devices may have cooling capacities of 125,000 BTU/h or less. In some embodiments, residential HVAC devices described herein may use single phase electric current or low-voltage DC current.

As discussed herein, the term “user” generally refers to a party that is a beneficiary of the energy control system described herein. The user may also have system operator status, administrator privileges and other relationships with the energy control system. In some of the embodiments discussed herein, the user is a homeowner that benefits from a home heating system that consumes fuel oil and implements the energy control system described herein.

As discussed herein, the term “service provider” generally refers to individuals, companies or entities that provide supplies of energy. In some of the embodiments discussed herein, the service provider delivers fuel, and may further provide for maintenance or other related services for maintaining a home heating system that consumes fuel oil.

As used herein, the term “stretch date” generally refers to a future date that must be reached before an energy supply is depleted. Depletion may be defined as exhaustion of the energy supply. Depletion may be defined as reaching a threshold in reduction of the energy supply (for example, a given percentage of the energy supply remains). The threshold may be user-defined, defined by a manufacturer, designer or other party.

Having introduced aspects of certain terms used in this disclosure, further aspects are now introduced.

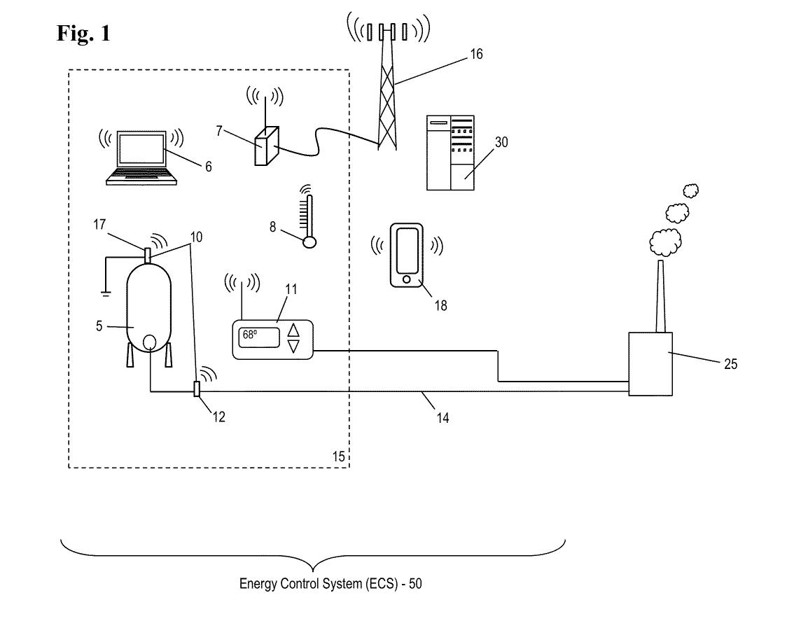

Generally, the control technologies introduced herein provide for monitoring use of the energy supply, a remaining quantity of the energy supply and adjusting a usage plan for consumption of the energy supply according to a budget. An introduction is provided below and with regard to FIG. 1.

Referring to FIG. 1, for an overview and an exemplary embodiment, an energy control system 50 includes a monitoring device 10 for monitoring heating oil stored within a residential storage tank 5. In the illustrative embodiment, the monitoring device 10 includes a supply monitor 17, such as a tank level monitor that is equipped with an ultrasonic sensor. In the illustrative embodiment, the monitoring device also includes a flow meter 12, such as a flow gauge that is equipped with a totalizing capability.

The monitoring device 10 is in communication with a system controller 6 (such as laptop for remote processing) through network 15. The monitoring device 10 provides electronic data regarding the quantity of heating oil left within the storage tank 5. The controller 6 is in further communication with a thermostat 11 that controls demand of an HVAC device 25. In the illustrative embodiment, the HVAC device 25 is a boiler that uses heating oil. As the level of heating oil in the storage tank 5 is consumed by the HVAC device 25, the energy control system 50 will cause conservation measures to be initiated according to a budget and to adjust a usage plan to limit consumption. Accordingly, an unprepared user is given further time to prepare for a complete ordering of additional heating oil.

The system controller 6 may include a plurality of devices. That is, functionality described as being implemented by the system controller 6 may actually be implemented, at least in part, by other devices within the energy control system 50. For example, aspects of system control may be implemented by microcontrollers included within a given monitoring device 10, a remote server 30, a remote system 18, and other devices that enable system control.

Generally, the monitoring device 10 monitors the available energy supply (in this embodiment, a level of heating oil in the storage tank 5) at a designated frequency or predetermined interval. Generally, monitoring is frequent enough that changes in the energy supply are recognized and accounted for by the control system throughout the day. Accordingly, in some embodiments, the monitoring device 10 may further include a flow meter 12 that is equipped with a totalizing function (that is, a device that is configured to monitor and account for draw from the energy supply). Generally, the flow meter 12 is placed in-line with the fuel supply 14 that flows to the HVAC device 25 for consumption (again, in this embodiment, from the storage tank 5).

The system controller 6 may be a computer that is included within network 15. The computer may be a desktop computer, a laptop, a tablet or other type of computer. The computer may be a remote computer, such as one that is operated by a service provider. The computer may perform necessary tasks to set up the monitoring device 10, and to add the monitoring device 10 to the network 15. In one embodiment, the user may access user controls within a router 7 to make associations for communications. Once the monitoring device 10 is set up within the network 15, the computer may be used to receive periodic broadcasts of monitoring data from the monitoring device 10.

Other components may be included in the network 15 and provide functionality to the control system 50. For example, at least one temperature sensor 8 may be included. The temperature sensor 8 may be used to monitor ambient temperature of the outdoor environment. In some embodiments, the temperature sensor 8 may be used to monitor temperature indoors. By using multiple temperature sensors 8, the ambient temperature at multiple locations may be monitored. Through use of the computer, a user may perform necessary tasks to set up the at least one temperature sensor 8 within the network 15. For example, the user may access user controls within the router 7 using a browser. In some embodiments, the temperature sensor 8 is configured to automatically join the network 15.

Communication within the network 15 may be performed in any manner deemed appropriate. For example, components included within the network 15 may communicate by use of Ethernet, wireless protocols such as Bluetooth, 802.11 or cellular protocols. In the example of FIG. 1, the monitoring device 10 is configured to communicate wirelessly with the router 7.

The network 15 may communicate with an external network. An exemplary external network includes a telecommunications provider 16. The telecommunications provider 16 may provide telecommunications that include wired communications (for example, as a landline). The telecommunications provider 16 may provide wireless communications (for example, cellular service).

The external network enables communication with remote system 18. Remote system 18 may include any type of remote computing device capable of displaying monitoring data provided by the energy control system 50. The various forms of data provided are discussed further here in. Exemplary computing devices include smart phones, hand-held units, tablets, laptop computers, desktop computers and the like.

The energy control system 50 may include (or have access to) additional resources such as the remote server 30. Generally, the remote server 30 facilitates data collection, data aggregation, data analytics, data forwarding and a variety of other tasks. Examples of remote servers 30 include remote computing systems dedicated to the control system 50 and may include commercially available services available to the general public on a contract basis. The remote server 30 may provide for at least some aspects of system control.

More detail is now provided regarding illustrative embodiments of the monitoring device 10.

Generally, the monitoring device 10 includes a sensor, a monitor controller, an interface, and supporting components. For example, where the monitoring device 10 is supply monitor 17 such as a tank level monitor, the monitoring device 10 may include an ultrasonic sensor, a microcontroller, a wireless interface, and a power supply all disposed within a housing.

The sensor may include any type of component or components appropriate for providing an electronic signal that is representative of the level of stock within the tank 5. Sensing may make use of mechanical (for example, a floating sensor), pressure, capacitive, inductive, acoustic, ultrasonic and/or optoelectronic measurement technologies. In short, sensing may make use of any technologies deemed appropriate to provide a desired function. For example, any type of technology that will provide point level detection, continuous level measurement, flow detection, current detection, and the like.

In one example of a sensor, a resistive strip is used. The resistive strip makes use of a solid-state sensor with a resistive output that varies with the level of the fluid. It easily interfaces with electronic control systems. The envelope for the resistive strip is compressed by the hydrostatic pressure of the fluid in which it is immersed. This results in a change in resistance that corresponds to the distance from the top of the sensor to the surface of the fluid. Output of the resistive strip is inversely proportional to the height of the liquid: the lower the liquid level, the higher the output resistance; the higher the liquid level, the lower the output resistance. One example is the ETAPE, provided by Milone Technologies, Inc of Sewell, N.J. Another exemplary sensor is the PING))) ultrasonic sensor available from Parallax of Rocklin Calif.

The monitor controller may include those components that are necessary or deemed appropriate for operating the sensor; for periodically receiving data from the sensor; controlling communications; and for communicating data. In some embodiments, the controller tracks at least some measurement data and performs error-checking. For example, in some embodiments, the monitor controller may be used to reject spurious measurement data such as modest increases in the stock. Rejection of measurement data may cause repeated measurement, and/or communication of a system fault. Tolerances for data rejection and error-checking may be set by the manufacturer, system designer, user or other similarly interested party.

Exemplary components for the monitor controller include a microcontroller connected to the monitoring components. Components of the monitor controller may be configured with a firmware application to monitor the monitoring data and communicate with outside requests. The monitor controller may contain an embedded web server and TCP/IP protocols for network/intranet communications. The monitor controller may communicate with an Ethernet connection, Bluetooth and/or Wi-Fi system. Embedded in the microprocessor is an IP address that permits users to connect with the monitor controller from any other smart device or PC using a web browser for data monitoring or other tasks. One example of a monitor controller is the RabbitCore RCM5400W, available from Digi International, Inc. of Minnetonka, Minn. Another example of a suitable monitor controller includes the RASPBERRY PI available through vendors for the Raspberry Pi Foundation of Cambridge, UK.

Generally, the monitor controller and/or the system controller 6 include components as are known in the art for performing computing tasks. That is, each of the monitor controller and the system controller 6 may include at least one processor as well as data storage, memory (RAM), a clock, a communications channel, a system bus, a user interface, firmware (ROM, such as a built in operating system, or BIOS), software, and other such components.

The interface of the monitoring device 10 may include any technology deemed appropriate. For example, communications may be through wired or wireless systems. Communications may be through traditional phone lines, the Internet, Ethernet or other such wired options. Wireless communications may be in any frequency deemed appropriate and may include protocol such as, Wi-Fi (802.11), Bluetooth, cellular, and other such protocols. In short, any type of communication system deemed appropriate for communicating data as needed to provide functionality described herein may be used.

The monitoring device 10 may include additional miscellaneous components such as a power supply. The power supply may include a DC power supply and/or a battery backup. The monitoring device 10 may include a local readout. In some embodiments, the monitoring device 10 includes user adjustable settings in order to properly correlate readouts with actual tank volume.

Generally, the monitoring device 10 is installed using existing architecture. For example, in the case of heating oil, where the monitoring device 10 is the tank level monitor, the tank level monitor may be screwed into a standard port on the storage tank 5 (such as a standard threaded port on a 275 gallon tank for home heating oil).

In short, the monitoring device 10 may include any type of technology deemed appropriate to provide for functionality described herein. Some non-limiting examples of aspects of the monitoring device 10 as a tank monitor are provided. Generally, the aspects are divided into monitoring components, local computing components, a communications channel and other miscellaneous components.

In some embodiments, a commercially available unit is used as the tank level monitor. One example is the ROCKET available from Beckett Corp. of North Ridgeville, Ohio.

An example of monitoring that is performed with the energy control system 50 is provided. In one embodiment, the supply monitor 17 includes a tank level monitor that senses a level of the stock within the storage tank 5 every hour. The tank level monitor provides the monitoring data with a time stamp as a data packet. A plurality of data packets may be used to trend volume within the storage tank 5. A variety of trending options are available to users. Trending may be performed, for example, with the system controller 6 or the remote server 30.

The amount of stock left in the storage tank 5, referred to as the “reserve” or “reserves” may be presented in any manner deemed appropriate. For example, the reserves may be presented as a fraction of a full tank (for example, X/8 of a tank left) and/or as a measured quantity (for example, X.XX number of gallons left).

In some embodiments, the monitoring device 10 includes the usage monitor 12. An example of the usage monitor 12 is a flow meter is placed into the flow path of the energy supply. Generally, the flow meter provides for monitoring a rate of consumption of the energy supply, and therefore may provide a sensitive measurement of the quantity of energy used.

In some embodiments, the monitoring device 10 combines data from the supply monitor 17 and the usage monitor 12. For example, the monitoring device 10 may use usage data from the usage monitor 12 to subtract volume from an initial quantity. The remaining quantity, which is a calculated value, maybe qualified as accurate by comparison with data from the supply monitor 17. A variety of such techniques may be used to obtain accurate data regarding reserves of the energy supply.

More detail is now provided regarding instruction sets for implementing the functionality described herein.

Generally, the system controller 6, the remote server 30 and the monitor controller(s) as well as any other components with processing capabilities include appropriate instruction sets for executing desired functions. The instruction sets include machine readable instructions that are stored on machine readable media (such as in ROM, RAM). The machine readable media may be considered “non-transitory.” The machine readable instructions (referred to herein as “software,” as an “application,” as a “client, a “process,” a “plug-in,” an “API” and by other similar terms) generally provide for functionality as will be discussed in detail further herein. In some embodiments, software is downloaded to memory (RAM) via a communications channel.

Some of the machine readable instructions stored on the machine readable media may include an operating environment. Software as provided herein may be developed in any language deemed suitable. Exemplary development languages include, without limitation, assembler, C (and the variants thereof), java, javascript and others. Aspects of the software may be implemented with other software. For example, user interfaces may be provided in XML, HTML and the like and implemented by a browser. Data may be stored in any type of database deemed appropriate, and manipulated with appropriate tools. For example, images, as well as the shapes and inventory of available dies may be stored in databases such as ORACLE provided by Oracle Corporation, of Redwood Shores, Calif.; SQL SERVER from Microsoft Corporation of Redmond, Wash.; and SYBASE of SAP Corporation of Dublin, Calif. Additionally, data libraries as may be generated herein (discussed below) may be managed accordingly. In short, software may be developed using any tools deemed appropriate by a user, designer, manufacturer or other similarly interested party.

Generally, application-programming-interface (API) modules are included with the energy control system 50. Accordingly, the energy control system 50 may be configured to recognize and cooperate with third party components (such as third party models of the monitoring device 10) as well as third party data (such as data from a weather service). APIs may be provided with an original software installation, downloaded from the remote server 30, or otherwise made available to the energy control system 50.

Task specific instruction sets for performing the tasks described herein may be adapted for any appropriate environment. For example, the instructions set may operate within computing environments provided by Apple Corp. of Cupertino, Calif. (iOS enviroments); Microsoft Corp. of Redmond Wash. (WINDOWS environments); Google Corp. of Mountain View, Calif. (Android) and other similar environments.

As an introduction, monitoring functions may include tank monitoring (monitoring of reserves) in combination with monitoring of environmental conditions. For example, the energy control system 50 may correlate reserves data with outdoor temperature data from the temperature sensor 8 or from a third party source, such as the National Weather Service or another publicly available resource.

In this manner, a user is able to track fuel use according to an external temperature. With knowledge of a weather forecast, the user is enabled to make predictions about fuel consumption over the near-term (that is, for the duration of the weather forecast).

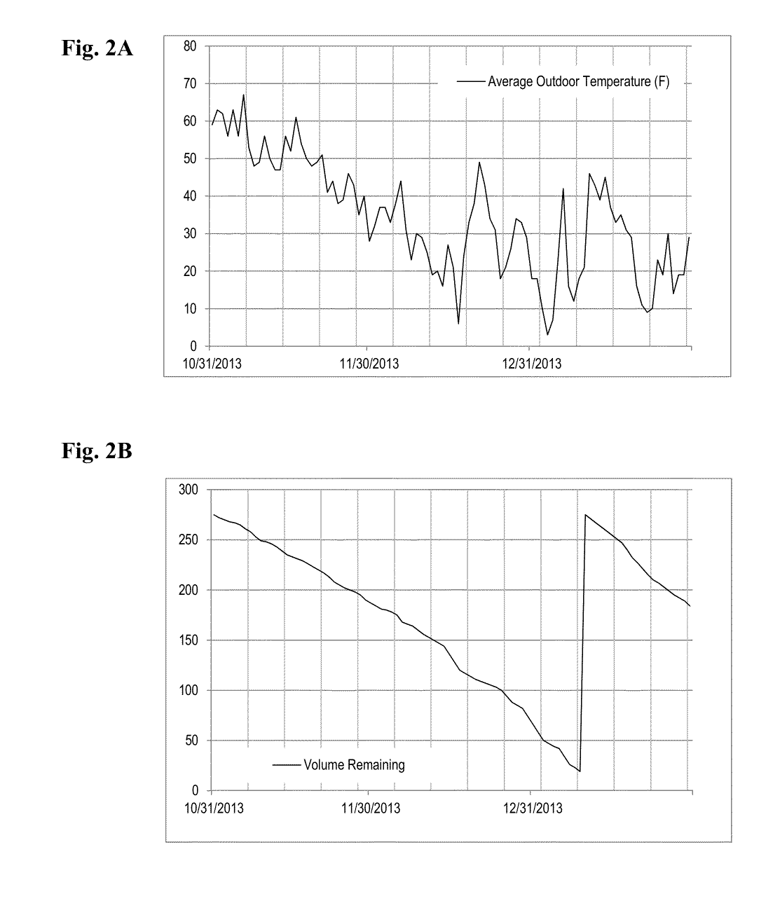

FIG. 2 is an exemplary graph showing fuel consumption as a function of outdoor temperature. Of course, a variety of other graphic forms may be presented. It may be seen that consumption generally increases with colder days. It may also be noted that the tank was refilled when nearing depletion.

FIG. 2A is a graph of actual average outdoor temperatures is provided by the National Weather Service. Average outdoor temperatures are attainable from the National Weather Service, or may be collected locally. For example, average outdoor temperature may be computed from data collected from the temperature sensor 8. FIG. 2B is a graph depicting dissipation of heating oil within a 275 gallon tank.

User interfaces such as graphics like those presented in FIG. 2, as well as other information may be presented using appropriate software adapted for the computer, the remote system 18, the remote server 30 or any other appropriate device.

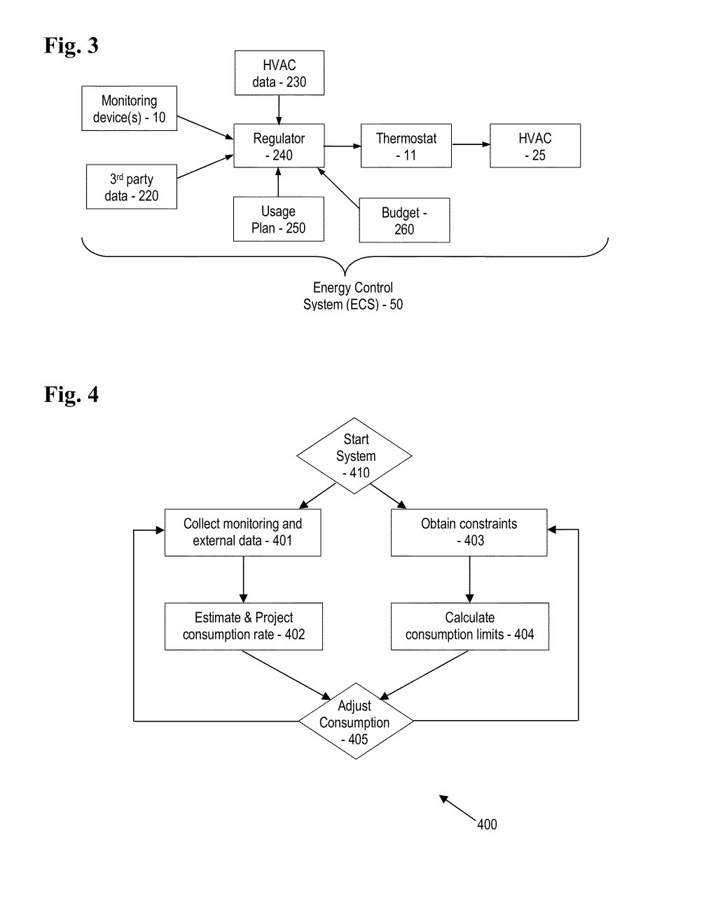

Turning now to FIG. 3, some functional aspects of an embodiment of the energy control system 50 of FIG. 1 are shown. Generally, the energy control system 50 includes components needed for regulating consumption. That is, the energy control system 50 receives reserves information from monitoring device 10. The monitoring device 10 provides measurements of the energy supply that remains in storage (also referred to as the energy “reserve” and by other similar terms). Third-party data 220, such as data from the National Weather Service may be collected by the energy control system 50. Collection of the third-party data 220 may be accomplished by, for example, the remote server 30. HVAC data 230 may be included and may provide consumption data such as rates of consumption for the HVAC device 25. The HVAC data 230 may include empirical data derived from learning algorithms or other such techniques. For example, the HVAC data 230 may account for the actual heat loss of a structure. In this example, regulator 240 combines the third-party data 220 with the HVAC data 230 and the usage plan 250 to forecast demands imposed on the fuel supply.

The regulator 240 compares the forecast demand with energy reserve and the budget 260 to derive at least one usage offset. That is, the regulator 240 calculates at least one usage offset (that is, adjustment to the user plan 250) according to limitations imposed by the budget 260. Accordingly, the forecast demand is revised in order to keep consumption of the energy reserve within the requirements of the budget 260. As the original usage plan 250 may include a variety of schedules and settings, the regulator 240 the calculate a series of appropriate usage offset values. Collectively, the series of usage offset values developed to implement the budget and adjust the usage plan 250 may be referred to as a “revised usage plan.”

The regulator 240 communicates the revised usage plan to the thermostat 11, which adjusts demand accordingly. Implementation of the revised usage plan provides for maintaining consumption of the energy supply within the budget 260.

Some additional aspects and embodiments of the energy control system 50 are now presented.

Generally, the usage plan 250 includes a plan for use of the energy reserves. In one embodiment (referred to as a “setting”), the usage plan 250 is simply a temperature setting for the thermostat 11. A more complex embodiment of the usage plan 250 (referred to as a “schedule”), includes a series of temperature settings. For example, a temperature setting to be used on a specific day and time, with subsequent adjustments to the temperature setting as time goes by. In an even more complex embodiment (referred to as a “zone plan”), the usage plan 250 includes a plurality of heating and cooling zones. Any one of the heating and cooling zones may be configured with a setting or a schedule of settings.

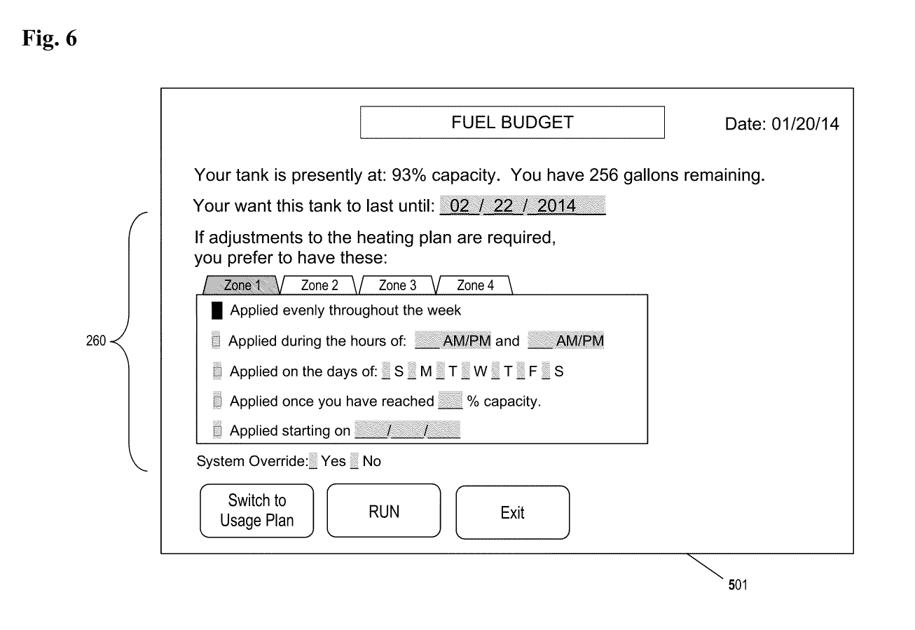

The budget 260 includes parameters for adjusting the usage plan 250. Generally, the budget 260 is configured for being referenced by the regulator 240. The budget 260 includes constraints and/or adjustments (as applicable) that may be applied to the usage plan 250. For example, one constraint may be reaching a given stretch date. One adjustment may include a temperature differential, such as an across-the-board reduction in selected heating temperatures for a given usage plan 250. The budget 260 is described in greater detail below and with regard to FIG. 6.

The regulator 240 may be implemented as a circuit and/or as software. The regulator 240 may be implemented as a separate component (such as a separate component in communication with the router 7 of FIG. 1); as software operated from a local computer (such as the controller 6) or a remote computer (such as remote server 30); and/or as a component within the thermostat 11. In some embodiments, aspects of the regulator 240 are divided into separate components. For example, the thermostat 11 may be provided with a rudimentary circuit for performing adjustment, while the server 30 may include sophisticated software for performing analytics needed to determine HVAC data 230 such as thermodynamic characteristics of the HVAC device 25 and generate forecasts. Accordingly, the term “regulator” generally refers to components required for performing the functionality described herein, and is not meant to imply a single, discrete component and therefore does not limit the teachings herein to a particular embodiment of hardware and/or software.

As discussed herein, the HVAC device 25 includes any device configured to consume and energy supply, such as the stock of heating oil that is stored in the tank 5. In the exemplary embodiment, the HVAC device 25 is a boiler that burns heating oil stored in the tank 5. In the exemplary embodiment, the boiler is suited for use in a single family dwelling. For example, the boiler may have a firing rate up to about 3.0 gallons per hour (GPH) and an input rating of up to 300,000 BTU per hour (BTU/hr), although these are not limitations. Generally, the boiler operates on a 120 volt AC, single phase signal, although this is not a limitation. The boiler may be of an on-off design, of a modulating design or any other suitable design. Generally, the boiler operates with number 1 or number 2 heating oil. However, the boiler may use other fuels (as outlined above). Generally, the boiler has a self-contained ignition circuitry, such as a continuous duty solid state igniter. Generally, the boiler operates with surrounding air. However, the boiler may be direct vented and receive external air.

The HVAC data 230 may be provided by a manufacturer, set by a service provider, and/or empirically derived. That is, the regulator 240 may generate a mathematical function describing HVAC data 230 according to operational characteristics correlated with demand from the thermostat 11 the third-party data 220 (such as outside temperature). Accordingly, the regulator 240 may continuously refine HVAC data 230 that was initially supplied to the energy control system 50. As such, the HVAC data 230 may be initially set by a manufacturer or service provider and then adaptively enhanced through usage of the energy control system 50. Other inputs for qualification of HVAC data 230 may include, without limitation, date, time of day, vacation settings, and other such inputs. Aspects of an exemplary process for governing operation of the HVAC device 25 are further illustrated in FIG. 4.

As discussed above, consumption rates (which are generally equivalent to and therefore interchangeably referred to as “flow”) may be monitored and provided to the regulator 240. In some embodiments, flow is known in advance (from the manufacturer), and the regulator 240 simply tracks on-off conditions of the HVAC device 25. In some embodiments, such as where a modulating burner is used, the flow meter 12 may be used to monitor flow (such as flow of heating oil from the tank 5) and provide for association of actual flow rates with consumption rates. Exemplary flow meters include in-line flow meters (such as a flow meter disposed in the fuel line after the fuel filter) as well as ultrasonic flow meters that may be surface mounted to the fuel line.

Other characteristics may be factored into the HVAC data 230, or maintained separately and provided as an input to the regulator 240. For example, insulation factors for the structure where the energy control system 50 operates may be considered, as well as numerous other dwelling ratings and characteristics.

In some embodiments, the energy control system 50 continuously tracks parameters and refine status such as the HVAC data 230. Accordingly, as operation of the energy control system 50 continues, accuracy of the HVAC data 230 is increased. Additionally, situational awareness of the energy control system 50 is improved. For example, by tracking information such as outdoor temperature (for example, through obtaining third-party data 220) and correlating the outdoor temperature with consumption rates, the impact of weather changes may be accounted for in advance. In some embodiments, the energy control system 50 may project usage accordingly, and alert the user as needed.

In FIG. 4, aspects of an exemplary method for operation 400 are provided. The method of operation 400 commences with system startup 410. System startup 410 may include initial startup (such as during initial installation), seasonal startup, recovery from a service episode or any other type of event. System startup 410 may include energizing hardware as well as entering settings into appropriate software.

Once system startup 410 has been completed, the regulator 240 will adjust consumption 405 on a continuing basis. Data collection 401 will be performed as the regulator 240 collects (or is provided) monitoring data from the monitoring device 10 and third-party data 220. Using the monitoring and external data in combination with the HVAC data 230, the regulator 240 will estimate and project consumption rate 402. At or nearly at the same time, the regulator 240 will obtain constraints 403 such as the budget 260. Using the constraints, the regulator 240 develops consumption limits 404. By comparing the consumption rate to the calculated consumption limit, the regulator 240 will determine the offset values. The regulator 240 will apply the offset values to the usage plan 250, as necessary, to reduce the consumption rate to no more than the calculated consumption limit and provide the revised usage plan. It should be recognized that the embodiments provided in FIG. 4 is merely one embodiment of many possible embodiments for operation of a regulating scheme, and is therefore merely illustrative and not limiting of the teachings herein.

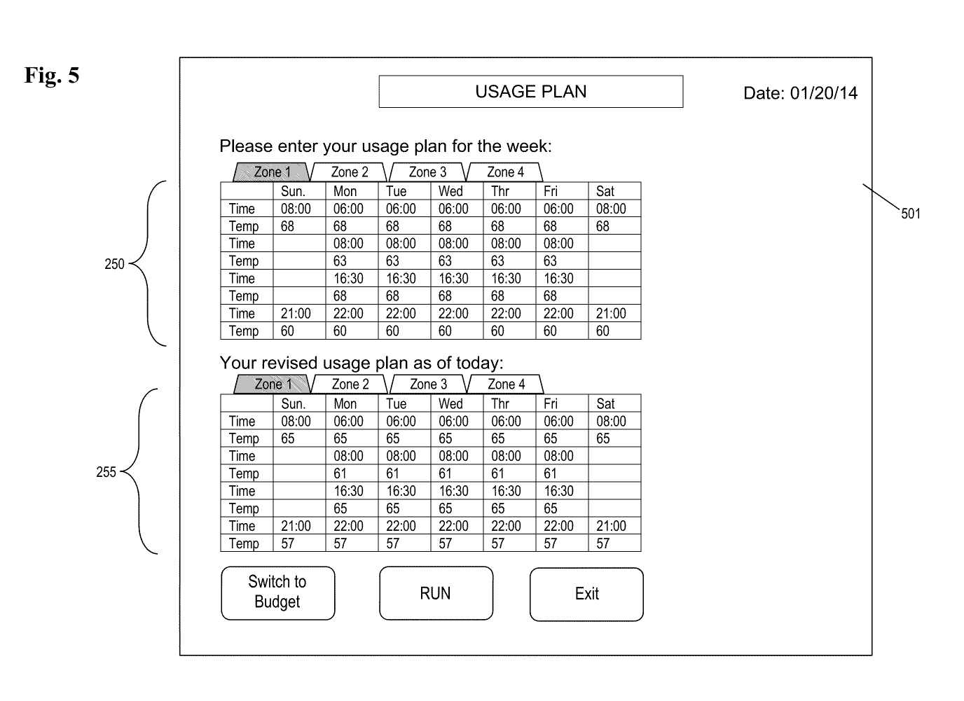

Referring now to FIG. 5, an exemplary embodiment of a user interface 501 is shown. In this example, the user interface 501 provides the usage plan 250. Another screen may be presented on the user interface 501 for input of the budget 260 (see FIG. 6). In some embodiments, the usage plan 250 is input locally into the thermostat 11 by the user. In these embodiments, the energy control system 50 may be configured to download the usage plan 250 as needed from the thermostat 11 and display the usage plan 250 on the user interface 501.

In the example shown in FIG. 5, the usage plan 250 may be input manually by a user. That is, in this example, the user is provided with a data table for the week. The user may simply enter data into the data table as deemed appropriate for the usage plan. Implementation of the budget 260 (shown in FIG. 6) may also be shown side-by-side with the usage plan 250. Of course, the revised usage plan 255 takes into account current conditions at the time of entering data into the usage plan 250. Changes in weather, configuration of the residence, or configuration of the HVAC device 25 may cause the revised usage plan 255 to become inaccurate.

In the embodiment shown in FIG. 5, the usage plan 250 as well as the revised usage plan 255 are presented in a tabular format. Each table is presented for a particular zone. By selecting (pointing and clicking on the) a tab above the tabular display, the user is able to switch between zones.

Regardless, the screen shown in FIG. 5 may be useful for the user to monitor the revised usage plan 255 at any given time. More specifically, while the user may be content with a particular usage plan 250, the user may want to monitor revisions imposed by the revised usage plan 255. Data entered by the user may post when a user moves from a data field, when the user selects “run” or in other ways that are conventional for data entry into a graphic user interface 501.

In the illustration of FIG. 5, the user interface 501 may include a toggle that permits the user to switch between entry or monitoring of usage plans 250, 255 with the budget 260.

Referring now also to FIG. 6, there is shown an exemplary user interface 501 that displays an input screen for the budget 260. The user interface 501 is provided on a device accessed by the user. For example, user interface 501 may be provided on a given computer such as the computer that implements controller 6 or remote system 18. In this example, the user interface 501 provides for collecting and recording user input for the budget 260. Additionally, the user interface 501 may provide the user with status information. Exemplary status information includes date, time, a present quantity of fuel remaining, a consumption rate, a date of last refill, and any other information deemed appropriate.

In this example, the user has selected requirements for making the reserve last about one month. That is, making the reserve last to a stretch data of Feb. 22, 2014. The user has opted to apply any reductions as an even offset that will be applied throughout the week.

The budget 260 may include information such as the stretch date. Additionally, the budget 260 may include preference information. Exemplary preference information includes, for example, user bias for calculation of an offset. More specifically, user bias may request that the regulator 240 apply any adjustments evenly throughout the day, only during certain hours, on certain days, only once a certain threshold has been reached, only for certain heating zones, beginning no earlier than a certain date and other similar preferences.

Referring back to FIG. 5, the user interface 501 further presents the revised usage plan 255. In the exemplary embodiment, the revised usage plan 255 is determined by the regulator 240 and then presented on the user interface 501. In this example, the revised usage plan 255 includes an offset of three degrees that is applied evenly throughout the week. This offset is a result of the stretch date that was selected by the user in combination with the demand characteristics of the HVAC device 25 (that are included in the HVAC data 230).

In some embodiments, providing the revised usage plan 255 permits the user to experiment with various options and to determine a preferable configuration for managing consumption in a manner that best suits need.

With regard to the budget 260, user input may be provided as combinations of preferences. For example, the user may prefer that the HVAC device 25 operate normally (without regulation) until a certain threshold is reached. At that point, the user may want the energy control system 50 to regulate two or three heating zones, while permitting normal operation in other heating zones. In short, a great variety of schemes for regulating consumption may be realized.

Algorithms for performing budgeting range from simple to complex. For example, if a user wants to set the thermostat to sixty eight degrees for one month during the heating season, the system may do a simple calculation of fuel required for each day of the month (for example, according to historic average temperature data available from the National Weather Service or other data supplier) and with consumption data for the particular HVAC device 25 (for example, the particular boiler or furnace). Consumption data may be collected over time and usage patterns may be empirically derived by the control system. If there is a projected shortfall in the amount of fuel available, then the control system may adjust the usage plan to a level that permits the user to “stretch” the fuel over the entire one month period.

Budgeting may become more complex when multiple thermostats (that is, multiple heating zones) are used. Budgeting algorithms may account for traditional budgeting features of thermostats such as scheduled ramping up and down of room temperature according to time and day of the week.

Advantageously, it is not necessary that offset calculations be precisely determined. That is, as monitoring may be performed on a continuing basis, offset calculations may likewise be performed on a continuing basis. Accordingly, algorithms used for implementation of the budget 260 may be refined over time, while still providing substantial performance when initially commissioned.

That is, where monitoring is performed on a continuing basis, calculation of the revised usage plan 255 may also be performed on a continuing basis. In some embodiments, monitoring may be performed on an hourly basis while calculation of the revised usage plan 255 is performed on a daily basis. As the energy control system 50 may be configured to operate autonomously, the latest manifestation of the revised usage plan 255 may account for any deviations in consumption (such as, if the energy control system 50 has been temporarily turned off (that is, subjected to a system override), if it is unexpectedly colder outside and other similar situations).

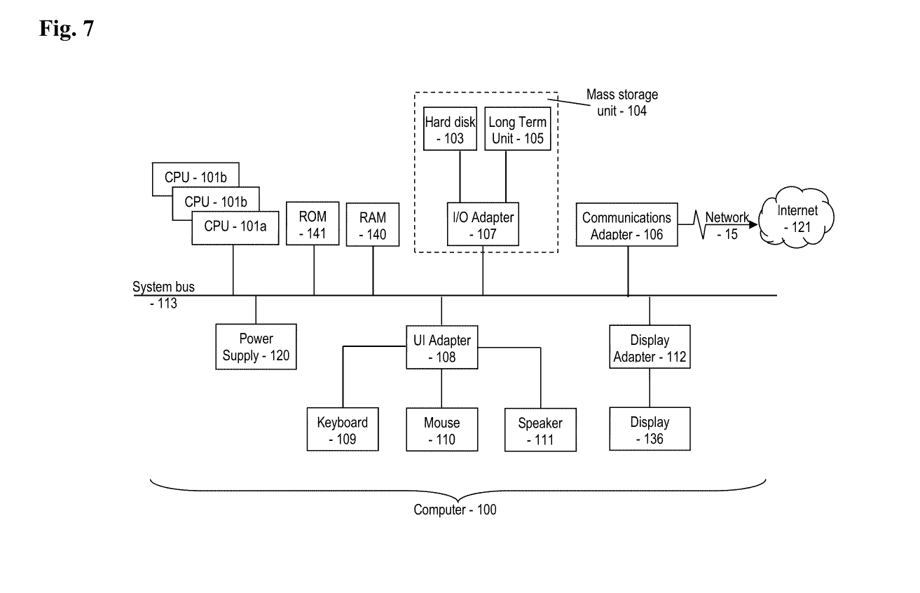

Referring now to FIG. 7, exemplary aspects of a computer 100 are depicted. Computer 100 has one or more central processing units (processors) 101a, 101b, 101c, etc. (collectively or generically referred to as processor(s) 101). Processors 101 are coupled to random access memory (RAM) 140 (also referred to “system memory,” or simply as “memory”) and various other components via a system bus 113. The computer 100 may include read only memory (ROM) 141 coupled to the system bus 113. The ROM 141 may include a built-in operating system (BIOS), which controls certain basic functions of computer 100.

FIG. 7 further depicts an input/output (I/O) adapter 107 and a communications adapter 106 coupled to the system bus 113. I/O adapter 107 may include parallel ATA (PATA, also called IDE or EIDE), Serial ATA (SATA), SCSI, Serial Attached SCSI (SAS), and Fibre Channel, or include any other type of interface deemed appropriate. The I/O adapter 107 generally provides for communicating with a hard disk 103 and/or long term storage unit 105 (such as a tape drive) or any other similar component (such as an optical drive). I/O adapter 107, hard disk 103, and long term storage unit 105 (and other similar components as may be included) are collectively referred to herein as mass storage 104.

A communications adapter 106 interconnects system bus 113 with an outside network 15 enabling computer 100 to communicate with other such systems. The communications adapter 106 may be supportive of at least of one of wired and wireless communication protocols. For example, the communications adapter 106 may support protocols such as wired Ethernet, wi-fi (e.g., 802.11 protocols), UMTS, dial-up, active-sync, cellular (using protocols such as, for example, GSM, GPRS, EDGE, CDMA, TDMA, 3G, 4G, and the like). Generally, the communications adapter 106 communicates with network 15, and may communicate (directly or indirectly) with the Internet 121.

The computer 100 is powered by a suitable power supply 120. In some embodiments, the power supply 120 includes at least one transformer for receiving alternating current (AC) and transforming the AC into a suitable form of direct current (DC). In other embodiments, the power supply 120 includes at least one battery. The power supply may include appropriate circuitry for receiving and controlling various forms of input power.

Input/output devices are shown as connected to system bus 113 via user interface (UI) adapter 108. A keyboard 109, a pointing device 110 (e.g., a mouse), and speaker 111 may be included and interconnected to system bus 113 via user interface adapter 108. Other user interface components may be included as deemed appropriate.

A display adapter 112 connects display monitor 136 is connected to system bus 113. The display adapter 112 and/or display monitor may be configured with various components, such as a graphics adapter to improve the performance of graphics intensive applications, a video controller, a capacitive (i.e., touch screen) display, and the like. The display monitor 136 may be used to display the user interface 501.

In some embodiments, adapters 106, 107, 108 and 112 may be connected to one or more input/output (I/O) busses that are connected to system bus 113 via an intermediate bus bridge (not shown). Suitable I/O buses for connecting peripheral devices such as hard disk controllers, network adapters, and graphics adapters may include common protocols, such as the Peripheral Components Interface (PCI) bus.

Generally, the computer 100 stores machine readable instructions on non-transitory machine readable media (such as in ROM, RAM, or in the mass storage unit 104). The machine readable instructions (which may be referred to herein as “software,” as an “application,” as a “client, a “process,” a “plug-in” and by other similar terms) generally provide for functionality as will be discussed in detail further herein.

In some embodiments, the machine readable instructions include drivers configured for communicating with commercially available components. For example, the drivers may enable the system controller 6 to communicate with other components such as with an off-the-shelf thermostat 11, an off-the-shelf monitoring device 10 such as the supply monitor and/or usage monitor, a conventional HVAC device 25, the temperature sensor 8 and other such components.

Some of the machine readable instructions stored on non-transitory machine readable media may include an operating environment. For example, and as presented herein, a suitable operating environment is WINDOWS (available from Microsoft Corporation of Redmond Wash.). Software as provided herein may be developed in, for example, SQL language, which is a cross-vendor query language for managing relational databases. Aspects of the software may be implemented with other software. For example, user interfaces may be provided in XML, HTML and the like.

The computer 100 may include, or exclude, as appropriate, the foregoing components and other components. For example, other components such as routers, bridges, firewalls, switches, servers, middleware and other components may be available. Some components may be implemented in software and/or hardware. For example, the term “server” may refer to an implementation of dedicated hardware with dedicated software running thereon. In some embodiments, the term “server” refers to a software engine running on hardware that performs other functions as well.

In some embodiments, the computer 100 may be designed and configured for stationary operation, while in some other embodiments the computer 100 is designed and configured for mobile operation. Some exemplary embodiments of commonly available mobile computers 100 that may be suited for practice of the teachings herein include laptops, smart-phones, tablets and the like.

A computing system may include a plurality of computers 100. For example, in the system, at least one computer 100 in the plurality may include substantial storage, memory, processors, mass storage and the like. Generally, such a configuration is useful as a “host computer” or a “base station.” At least one computer 100 in the plurality may be designed with mobility as a primary purpose. For example, memory may replace a hard disk due to a physically compact nature of the memory. Generally, such a configuration is useful as a “mobile computer,” a “mobile station” or by other similar terms.

Embodiments of the computer may include a variety of devices. For example, a specialty device such as the thermostat 11 may include at least a portion of the components for the computer 100. Other embodiments of the computer 100 may include: a mainframe, a server, a personal computer (PC), a tablet computer, a mobile computing device and a smart phone.

A particular computer 100 in a computing system may be purpose-oriented. For example, a computing infrastructure may use one computer 100 principally as a file server (i.e., a data storage device for efficient storing of data within the computing infrastructure), a plurality of other computers 100 as input devices (e.g., as mobile stations operated remotely by users for interfacing with the computing infrastructure), as a console (e.g., a dedicated system for managing the computing infrastructure), and the like.

It should be recognized that some functionality as may be described herein may be implemented by hardware (such as by the foregoing components), or by software, as appropriate. Accordingly, where reference is made to implementation in one manner or another, such implementation is merely illustrative and is not limiting of techniques described. In short, the foregoing description of the computer 100, and systems making use of or incorporating the computer 100, merely provides an environment for the teachings herein and is not to be construed as limiting, but as illustrative of aspects of the computer 100 and systems that incorporate the computer 100.

Given the highly configurable nature of computing systems, the term “computer” 100 is to be construed to include any configuration of components and/or software as needed to provide for the intended functions as well as extensions thereof. In some embodiments, the computer 100 includes at least one microcontroller.

Generally, the computer 100 implements a software solution that enables users to control HVAC systems according to a budget. The computer 100 may implement third party software systems for various purposes, such as communications, messaging, scheduling, analyses, and for other such purposes. The use of the term “user software” is merely for introduction of the exemplary embodiment, and is not limiting of the teachings herein.

Having thus introduced aspects of a system for regulating consumption, some additional aspects are now discussed.

Communications by any of the components described herein may be realized using any technology deemed appropriate. For example, communications may be through wired or wireless systems. Communications may be through traditional phone lines, the Internet, Ethernet or other such wired options. Wireless communications may be in any frequency deemed appropriate and may include protocol such as, Wi-Fi (802.11), Bluetooth, cellular, and other such protocols. In short, any type of communication system deemed appropriate for communicating data as needed to provide functionality described herein may be used.

A system for regulating consumption may further include components for providing analytics. For example, the server may be configured for collecting information from a diversity of individual system implementations. Software operating on the remote server 30 or in communication with the server may be used to identify a variety of forms of information. For example, analytics may identify usage patterns, socio-economic concerns, performance anomalies (such as poor performing systems, as well as highly performing systems) and other such information.

The user may use the remote system to obtain account information in a variety of forms. For example, the user may log into an account that is stored on the server using a browser such as Internet Explorer, available from Microsoft Corporation of Redmond Wash. Software running on the server may provide the user with graphic displays which inform the user as to consumption of the stock over time.

In the exemplary embodiments discussed herein, the energy supply includes liquid feedstock that is heating oil. However, the teachings herein are not limited to use with heating oil and residential heating systems that consume the heating oil. Generally, the systems disclosed herein provide a feedback loop that permits a user to monitor and control consumption.

Consumption that may be monitored may be derived from heating, cooling, air handling, or other HVAC devices.

Third-party data 220 may include a variety of types of information. For example, third-party data 220 may include meteorological data, electrical rate plans, commodity prices (such as the price of heating oil provided by a particular service provider or on the open market), and other types of information that may be useful to the energy control system 50.

The monitoring devices employed may monitor a reserve of an energy supply (such as a quantity of heating oil, propane or other volumetric commodity) and/or continuously dispensed forms of energy (such as natural gas and/or electricity).

The energy control system 50 may be configured to control multiple systems. For example, the energy control system 50 may be configured to control consumption of home heating oil during the winter, and electricity used to provide air-conditioning during the summer.

Some additional exemplary monitoring devices include mass flow meters, inductive meters and a wide variety of other devices implementing various technologies. Exemplary technologies implement at least one of a float sensor, a pressure transducer, a submersible transducer, an optical sensor, a conductivity sensor and another sensing device of similar functionality.

Some electricity monitoring solutions are available from Smart Solutions Group, Inc. of Auburn Wash. Examples include the Plug-in Energy Metering device referred to as “Smart-Watt.” Smart-Watt is designed for any circuit. A user only needs to connect the male plug to the power source and connect the HVAC device to the female receptacle. Smart-Watt continuously monitors the circuit and records the cumulative energy consumption by the attached devices in 1/10th watt-hour increments. In addition to cumulative energy usage, Smart-Watt can also determine the load on a circuit over any reading period in watts. Data can be logged to provide highly accurate load profiles for each monitored circuit. Other suitable devices are available from this manufacturer, as well as other manufacturers.

Although the disclosure provided generally refers to residential systems, this is merely illustrative and is not limiting of the teachings herein. That is, in some embodiments, the energy control system may be used exclusively to govern residential type HVAC devices. However, this is not limiting. That is, the technology disclosed herein may be applied to commercial and industrial HVAC systems.

Standards for performance, selection, usability, manufacture, longevity, and other such concerns are to be determined by a user, designer, manufacturer, or other similarly interested party. Generally, standards for performance may consider adequacy of performance (i.e., functionality), cost, availability and other such concerns.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not meant to be construed as a superlative, and is merely indicative of one embodiment of other available or possible embodiments.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An energy control system configured for regulating consumption of an energy supply by a residential heating, ventilation or air conditioning (HVAC) device, the energy control system comprising:
a monitoring device configured for monitoring energy consumption by the residential HVAC device;
a user interface for inputting a usage plan and inputting a budget for the energy supply; and,
a system controller for providing a revised usage plan by adjusting the usage plan to limit the energy consumption to conform with the budget.

2. The energy control system as in claim 1, wherein the monitoring device comprises at least one of a supply monitor and a usage monitor.

3. The control system as in claim 2, wherein the supply monitor comprises a device configured for monitoring the quantity of one of a liquid and a gas.

4. The control system as in claim 2, wherein the usage monitor comprises a device for monitoring at least one of flow of a liquid, flow of a gas, and usage of electricity.

5. The control system as in claim 1, wherein the system controller is configured to factor third-party data into the revised usage plan.

6. The control system as in claim 5, wherein the third-party data comprises at least one of: outdoor temperature, indoor temperature, building description information, and HVAC performance characteristics.

7. The energy control system as in claim 1, comprising a user interface for inputting at least one of the usage plan and the budget.

8. The energy control system as in claim 7, wherein the user interface is presented to the user by one of: a thermostat, a personal computer, a tablet computer, a mobile computing device and a smart phone.

9. The energy control system as in claim 1, wherein the monitoring device comprises at least one of: an ultrasonic sensor, a mechanical sensor, a pressure sensor, a capacitive sensor, an acoustic sensor, and an optoelectronic sensor.

10. The energy control system as in claim 1, wherein monitoring device comprises at least one of a device controller, memory, and a communications channel for communicating with the system controller.

11. A method for fabricating energy control system for an HVAC device installed within a residential dwelling, the method comprising:
selecting a monitoring device configured for monitoring energy consumption by the residential HVAC device;
selecting a user interface for inputting a usage plan and inputting a budget for the energy supply; and,
providing a system controller for providing a revised usage plan by adjusting the usage plan to limit the energy consumption to conform with the budget.

12. The method for fabricating an energy control system as in claim 11, wherein the system controller comprises a set of computer executable instructions stored on non-transitory machine readable media, the instructions configured for:
receiving the usage plan, the budget and consumption information; and,
calculating at least one offset value for the usage plan to provide the revised usage plan.

13. The method for fabricating an energy control system as in claim 11, wherein the system controller is configured to perform the receiving and the calculating autonomously.

14. A computer program product comprising a set of computer executable instructions stored on non-transitory machine readable media, the instructions configured for managing a residential HVAC energy control system by implementing a method comprising:
receiving a usage plan, a budget and consumption information for a residential HVAC device; and,
providing a revised usage plan by adjusting the usage plan to limit the energy consumption to conform with the budget.

15. The computer program product as in claim 14, wherein the receiving further comprises receiving third-party data that comprises at least one of outdoor temperature, indoor temperature, building description information, and HVAC performance characteristics.

16. The computer program product as in claim 14, further comprising instructions for monitoring correlation of the revised usage plan the budget and the third-party data.

17. The computer program product as in claim 16, further comprising instructions for adjusting factors derived from correlation data and used in algorithms for providing the revised usage plan.

18. The computer program product as in claim 17, further comprising a remote server configured for at least one of receiving at least one of correlation data, algorithms, third-party data, usage plan data, budget data, and revised usage plan data and deriving improved algorithms from received data.

19. The computer program product as in claim 14, further comprising at least one driver configured for enabling communication between a system controller and another component.

20. The computer program product as in claim 14, further comprising instructions for providing a revised usage plan for at least one zone of a plurality of zones.
